(19) United States
(12) Patent Application Publication
(10) Pub. No.: US 2005/0008425 A1
(43) Pub. Date: Jan. 13, 2005

(54) Binder

(75) Inventors: Makoto Mori, Katsushika-ku (JP); Hitoshi Kawachi, Katsushika-ku (JP)

Correspondence Address: OLIFF & BERRIDGE, PLC, P.O. BOX 19928, ALEXANDRIA, VA, 22320, US

(73) Assignee: CARL MANUFACTURING CO., LTD., Katsushika-Ku (JP)

(21) Appl. No.: 10/843,391

(22) Filed: May 12, 2004

(30) Foreign Application Priority Data
May 15, 2003 (JP) 2003-137427

(51) Int. Cl. B42F 3/02

(52) U.S. Cl. 402/57

(57) ABSTRACT

A binder with the plurality of binding portions (curl rings, etc.) has indication(s) such as projection, hollow, paint, etc. at each end of the binder or both ends thereof enabling users to quickly and simply identify a direction of the binder to bind papers without errors. Users can identify the binding direction only through visibly or tactilely confirming the indication(s) thus improving efficiency of binding operations.

### BACKGROUND OF THE INVENTION

1. Field of the Invention

The present invention relates to a binder with an indication enabling users to easily identify a direction to bind papers, etc. without errors.

2. Related Art

Conventionally, a binder provided with the plurality of binding portions may have been used to bind papers. In this case, the papers have holes usually by the side thereof, and the binding portions are inserted into the holes so as to be bound as shown in FIG. 5A. There are many kinds of binders. One example may be a ring binder having plastic curl rings or comb rings as the binding portions.

As shown in FIG. 5B, a binder 1 is composed of a longitudinally-extended base 3 and curl rings 2 circularly extending in a circumferential direction from the base 3. The plurality of cur rings 2 arm sequentially provided on the base 3, and points 2a of the curl rings 2 may be formed into taper for easy binding. The curl rings 2 and the base 3 are generally made of plastic and formed by integral molding. The curl rings 2 are circularly curved with heat, so that the points 2a of the curl rings 2 are made to touch onto the base 3. Thus, the curl ring 2 are energized forming closed loop approximately circular. But, at the same time the curl rings 2 have flexibility as a curl ring 2′ in FIG. 5B, whereby the curl rings 2 are forced to be opened when external force beyond the energized force is applied, so that the points 2a inset into holes 8 of papers 9 in arrow X direction.

In the present invention, specific binding methods are not disclosed, but the method disclosed in Japanese Patent Application Laid-Open No. 2001-191678 hereinafter reference 1) may be applied. In the reference 1, a binder is positioned with a binding auxiliary or a binder setting tool, and then curl rings are opened with a ring opener, etc. for binding. Or, a plastic ring binder, etc. may be applied. See P. 16 of 2001 General Catogue produced by Carl Manufacturing Co., Ltd. (hereinafter reference 2).

When using the binder 1, a direction of the curl rings 2 should be arranged so as to enable to bind the papers 9. However, as discussed hereinbefore, because the point 2a of the curl rings 2 touch to the base 3 due to energized force forming the closed loop approximately circular, the ring binder 1 looks like bilateral symmetry at a glance, which hampers immediate identification as to in which direction the binder 1 should be arrange. If proper identification is failed, it leads correct binding unsuccessful. Accordingly, based on the conventional methods described in the reference 1 and the reference 2, users are required to check on if the binder is properly arranged to bind the papers. For excluding the above bother, a binder in which users can identify a direction to easily and simply has ben desired.

### SUMMARY OF THE INVENTION

In view of the forgoing situations, it is an object of the present invention to provide a binder which enables users to quickly and simply identify direction thereof to bind papers (hereinafter binding direction) without errors.

In order to achieve the above object, the present invention provides a binder having the plurality of binding portions, in which the binder has an indication identifying the binding direction. In this structure, users can quickly and simply identify the binding direction only through visibly or tactilely confirming the indication thus improving efficiency of binding operations (hereinafter invention 1).

Further the present invention according to the invention 1 is characterized in that the indication is either projection or hollow provided on one end of a base of the ring binder. In this structure, can specifically identify the binding direction with the projection or the hollow (hereinafter invention 2).

Furthermore, the present invention according to the invention 1 is characterized in that the indication has the projection provided on one end and the hollow provided on the other end of the base of the binder wherein the projection fits the hollow. In this structure, users not only can identify the binding direction but also manufacture the projection and the hollow with a common tool (hereinafter invention 3).

And, further, the present invention according to the invention 1 is characterized in that the indication may be a punching portion, a swell portion or a print portion. In this structure, only one end of the base portion of the ring binder needs to be prepared for the punching portion, the swell portion or the print portion, so that users can identify the binding direction (hereinafter invention 4).

And, furthermore, the present invention according to the invention 4 is characterized in that the indication is formed into arrow. In this structure, the indication can have directionality, thus users can easily identify the binding direction (hereinafter invention 5).

Finally, the present invention according to the invention 1 is characterized in that the indication is the one painted on one end of the binder. In this structure, there is no need to machine the binder (hereinafter invention 6).

The binder of the present invention is basically as described above but preferably provided with curl rings as the binding portion. In this case, the indication show the binding direction may be provided at either end or both ends of the binder. Or, the indication may be provided in a middle portion of the binder. The indication may be provided when manufacturing the binder, or it may be provided through another processes. The indication may be provided by a cutting process, punching process, etc . . . . And, the indication may be provided by another methods such as painting process, etc . . . . Further, while the indication may be integrally provided with the binder, it may be provided separately with the binder. Furthermore, the binder of the present invention is not limited to a ring binder but may be, for example, a twin-ring binder. Lastly, the present invention is not limited to papers for binding but the papers can be replaced by plastic thin plate, etc.

### BRIEF DESCRIPTION OF THE DRAWINGS

FIG. 1A is an overview diagram of a binder of the present invention, and FIG. 1B shows one embodiment of the present invention having projection and hollow at both ends of he binder;

FIG. 2 shows another embodiment of the preset invention having an indication punched through at only one end of the binder;

FIG. 3 shows further another embodiment of the preset invention having an indication printed at only one end of the binder;

FIG. 4 shows still further embodiment of the present invention having an indication separately provided with the binder; and

FIG. 5A shows a conventional binder and papers bound, and FIG. 5B shows a unit of the binder of FIG. 5A.

### DESCRIPTION OF THE PREFERRED EMBODIMENTS

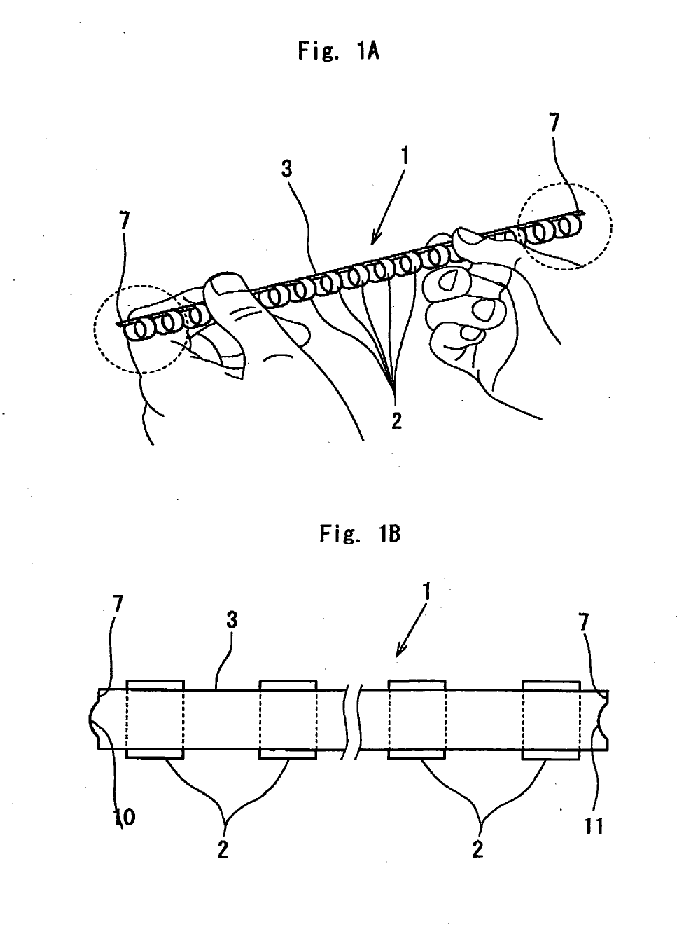

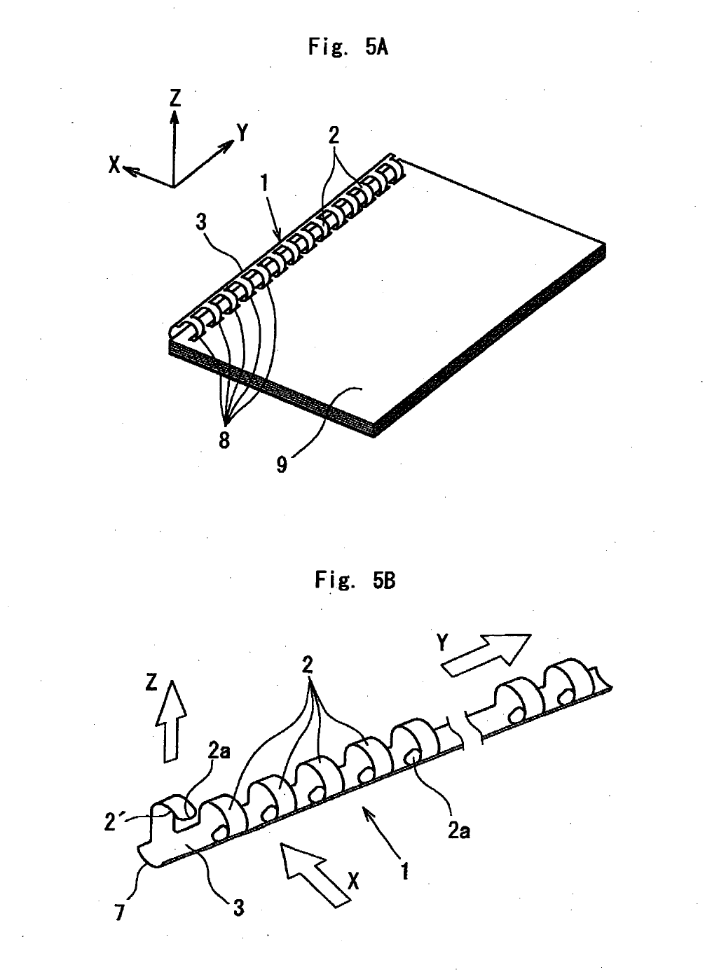

Embodiment of the pet invention will be described with reference to accompanying drawings. FIG 1A shows a binder 1 of the present invention having the plurality of curl rings (binding portions) 2. The curl rings 2 are inserted into holes 8 precedently punched through at side end of papers 9. See FIG. 5A. Preferably, the binder 1 is a ring binder successively provided with the plastic curl rings 2 on a base 3. The curl rings 2 are integrally formed on the base 3 and curvedly extended. See FIG 5B. And, points 2a of the curl rings 2 touch to the base 3 with given energized force. But, concurrently, the curl rings 2 have flexibility, whereby the curl rings 2 are forced to open when external force over the energized force is applied thereto. See 2′ are in FIG. 5B. And, when the external force is removed the curl rings 2 are again returned to their original shape with the energize force. Accordingly, when one side of the curl rings 2 are opened as above, the papers 9 are bound with the binder 1 in a direction X. Hereinafter refer to direction X as a binding direction to bind papers with the binder 1.

The curl ring 2 have the following advantages: 1) since being formed into approximately cylindrical shape, the papers bound can turn with no displacement in a vertical direction; 2) because being made of plastic, low-cost production is possible; and 3) because of flexible characteristic, binding operations can be repeatedly performed. On the other hand, the conventional curl rings are looked in bilateral symmetry, thus it may hamper users'immediate identification of which direction the curl rings should face to achieve the binding direction. In the present invention, indication(s) is (are) provided with the binder 1 allowing users to face the binder 1 in the binding direction. In this structure, users can attain quick and simple identification of the binding direction without errors only through visible or tactile conformation

With the indication, users can identify left-hand side and right-hand side of the longitudinally-extended binder 1 (the left-hand side means position provided with projection 10 while the right-hand side means the position provided with hollow 11 in the present invention and as shown in FIG. 1B) thereby quickly confirming the binding direction of the binder 1. For examples, when the holes 8 are formed on the left end of the papers 9 as shown in FIG. 5A, the side shown as Y arrow should be the upper side of the binder 1 so as to constantly face the binder 1 in the binding direction. In this position, the curl rings 2 open upward, that is, in a direction shown as arrow Z Although the binding direction is not limited to the above method, the binding direction will be determined in a manner of confirming the direction of the binder 1 similarly based on the above.

The indication(s) will be any arbitrary s sizes and provided on any appropriate places of the binder 1. But, by providing the indication at both ends 7 of the binder 1 as shown in FIGS. 1A and 1B, users can perform easier visible or tactile identification to face the binder 1 in the binder direction. Because users will not be hampered from identifying the binding direction as discussed above, any binding equipments can be applied to set the binds 1 in appropriate direction.

As shown in FIG. 1B, the indication is provided at each end 7 of We binder 1. An indication 10 in a projection shape shows a left-hand side portion of the binder 1 while an indication 11 in a hollow shape shows a right-hand side portion of the binder 1. Based on FIGS. 1A and 1B, the indication 10 is formed into approximately circular in such a manner as to outwardly project from the end 7 of the base 3. On the other hand, the indication 11 is also formed into approximately circular but inversely excised to make a hollow shape on the base 3. The indications 10 and 11 fit each other. Thus, users can easily identify the direction of the binder 1, that is, the binding direction, only through visible or tactile confirmation of either the indication 10 or the indication 11, or both.

Shapes of the indications are not limited to FIG. 1B but may be other shapes such as approximately trapezoid, triangle, etc. Thus, the indication 10 can be any shape as long as it projects from the end 7 of the base 3. Like the indication 10, the indication 11 may be also any shape as long as it makes a hollow shape distinguishing from the projection of the indication 10. And, as discussed, the projection of the indication 10 fit to the hollow of the indication 11 making a pair.

As shown in FIG. 1B, one end 7 of the base 3 will be formed into projection, and the other end thereof will be formed into hollow, whereby users can identify the binding direction of the binder 1. However, as said above, there will be no need to specify the shape of the indication as long as users can identify the binding direction of the binder 1. Furthermore, there may be not necessary for the indications 10 and 11 to fit each other to be a pair. Further, users can identify the indications 10 and 11 through the sense of either vision or touch, or both.

The indications 10 and 11 can be manufactured in some different manners. For example, the indications 10 and 11 may be formed when the binder 1 is molded in die. In this case, arbitrary shapes of the indications 10 and 11 may be formed by altering shape of the die. Or, after molded in die, the length of the base 3 of the binder 1 may be necessary to cut for satisfying paper standards. In this case, the indications 10 and 11 may be formed when cutting the length of the base 3. Here, arbitrary shapes of the indications 10 and 11 may be formed by changing cutting tools. Furthermore, a common tool may be applied to fabricate a pair of identifications. And, further, the indications 10 and 11 may be formed in a different manufacturing process from the binder 1.

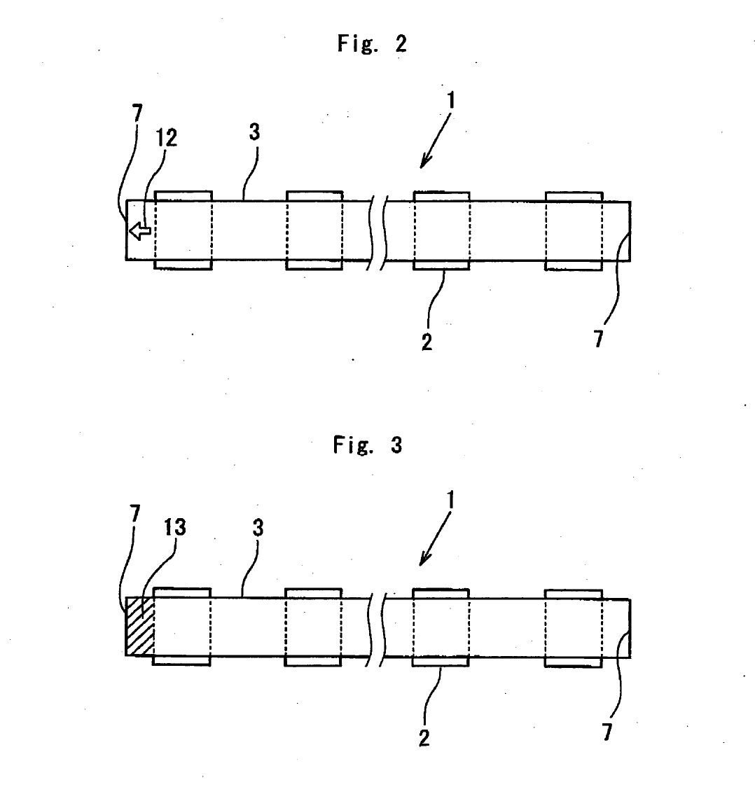

And, the indication does not need to be always provided at both ends 7 of the base 3 as shown in FIG. 1B but may be provided only at one end. For example, as shown in FIG. 2, an indication 12 is provided only at one end 7 of the base 3 but enables to show the binding direction to users. The indication 12 is formed into arrow shape showing the left-hand side of the binder 1. Because the arrow-shaped indication 12 is provided only at one end 7 of the base 3, it has already had directionality. In addition, the indication 12 does not need to be the arrow-shape but may be any arbitrary shapes such as circular, star, etc . . . .

The indication 12 may also be formed when the binder 1 is molded in die or when the base 3 is cut as described above. Or, the indication 12 may be formed in a different manufacturing process from the binder 1. Here, the indication 12 may be formed by punching through the base 3 or by fabricating a convexo-concave swelling portion on the surface of the base 3 without punching through the base 3.

Further, the indication may be formed without machinery but formed by partially changing color, etc of either end 7 of the base 3. Specifically, an indication 13 may be formed by printing or painting either end 7 of the base 3 to show the left-hand side of the binder 1. In this structure, users can also easily identify the binding direction. Here, the place where the indication is provided is not limited to the end 7 but may be provided at any place on the base 3 if deviating from its central position thus obtaining directionality. The indication 13 may be any arbitrary shape such as patterns, alphanumeric markings, etc. Furthermore, the indication 13 does not always need to be provided on the base 3 but may be provided on the curl rings 2 by being painted. Of course, by providing the indication 13 at both the curl rings 2 and the base 3, users can more easily identify the binding direction. In addition, the indication 13 does not need to have color from the one of the base 3. But, when painting the base 3, the indication 13 may be formed by not paining specific portion(s) thereon. Or, the indication 13 may be any arbitrary sealing member which can be affixed to the base 3.

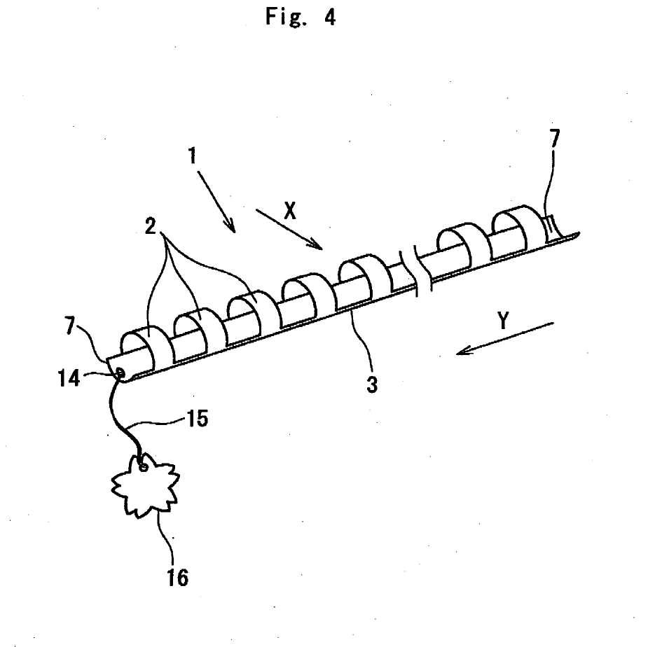

Still further, the indication does not need to be formed integrally with the ring binder 1. As shown in FIG. 4, any arbitrary member 16 may be separately provided at either end 7 of the base 3 to show the binding direction. For example, as shown in FIG. 4, either end 7 of the base 3 is perforated (perforation 14), and the member 16 is provided with an arbitrary joint member 15 such as string, chain, etc. The indication 16 may be arbitrary material, shape and size. The peforation 14 may be indication 12 of FIG. 2 punched through the base 3.

One advantage of the indication 16 can be said that users can quickly identify the binding portion when picking up the binder 1 through not only visibility but also weight of the indication 16. Here, the indication 16 may be formed to contribute to the improvement of design of the binder 1 while identifying the binding direction. Of course, the indication 16 may be a name plate or a bookmark giving more functionality.

As discussed with Figs., the indication 10, 11, 12, 13 or 16 in the present invention may be provided with the binder 1, so that users can quickly identify the binding direction of the binder 1 without errors thus improving efficiency of binding operation. Here, the indication may be provided either end 7 of the base 3 or both ends 7 thereof (see broken lines of FIG. 1A or FIG. 1B). However, the indication(s) is (are) not limited to always be provided on end(s) 7 of the base 3, but it may be provided in the center thereof. But, if provided in the center, the directionality of the binder 1 is not identified. Thus, in this case, the indication may be arrow-shape giving directionality, thus users can identify the binding direction.

Furthermore, the press invention is not limited to a ring binder discussed above, but it may be a twin ring, a double ring or a double-loop ring in which a piece of wire is used (hereinafter referred to as twin-ring binder). In this twin-ring binder, its opened cross section before binding is pressed to close so as to bind papers. Here, it will be necessary for the twin-ring binder to determine the direction to be pressed. In Conventional manners, users are required to direct the twin-ring binder in the binding direction. In the present invention, the arbitrary indication(s) may be provided with the twin-ring binder fixing the binding direction. In this case, the indication may be provided in such a manner as to arbitrarily deform one end of the twin-ring binder determining the binding direction. Or, the embodiments of the present invention shown in FIGS. 1 to 4 may apply as discussed above.

1. A binder having the plurality of binding portions, wherein an indication portion is provided identifying a direction to bind papers.

2. A binder according to claim 1, wherein the indication portion is either projection or hollow provided at one end of a base of the binder.

3. A binder according to claim 1, wherein the base has the projection provided at one end thereof and has the hollow provided at the other end thereof, and the projection and the hollow fit each other.

4. A binder according to claim 1, wherein the indication is a punching portion, a swell portion or a print portion provided at one end of the base of the binder.

5. A binder according to claim 4, wherein the indication is formed into arrow.

6. A binder according to claim 1, wherein the indicating is formed with painting at one end of the binder.
